(19) United States
(12) Patent Application Publication
(10) Pub. No.: US 2015/0313325 A1
(43) Pub. Date: Nov. 5, 2015

(54) STRAP AND THE METHOD OF MANUFACTURE

(71) Applicant: Von West, Inc., Salt Lake City, UT (US)

(72) Inventors: Mark Henry West, Park City, UT (US); Evan Ralph West, Park City, UT (US); Jonathan Neil Hart, Salt Lake City, UT (US)

(21) Appl. No.: 14/267,901

(22) Filed: May 1, 2014

(51) Int. Cl. A44C 5/00; B32B 43/00; B32B 38/00; B32B 37/12

(52) U.S. Cl. CPC A44C 5/0015; B32B 37/1284; B32B 43/006; B32B 38/0036; B32B 2307/20; B32B 2375/00; B32B 2451/00; B32B 2519/00; B32B 2457/00

(57) ABSTRACT

There is a strap that may include an elongated flexible, a transparent solid dome of polymer resin (urethane) and that is free of adhesives. The strap includes a second solid dome disposed on a second side, a decorative layer disposed between the first side and the solid dome, a decorative element embedded with the solid dome, a coupling device, and an electronic device imbedded in the solid dome. There is a method of manufacturing a strap, including the steps of providing a flexible substrate coupled to a carrier sheet; applying a liquid polymer resin over a majority of the first side of the elongated flexible substrate; hardening the liquid polymer resin; separating the flexible substrate from the carrier sheet; applying and hardening a liquid polymer resin on the second side; printing a decorative layer; and cutting the flexible substrate and removing flexible substrate material between cuts.

### BACKGROUND OF THE INVENTION

1. Field of the Invention

The present invention relates to straps, specifically to domed straps and methods of manufacturing thereof.

2. Description of the Related Art

Straps may be used as fasteners to attach and bind items, to objects, animals (for example a saddle on a horse) and people (for example a watch on a wrist), or even to tie down objects. Occasionally a strap is specified after what it binds or holds, e.g. chin strap. Straps are generally elongated flexible members that are used to bind, wrap, couple, cinch, or otherwise interact with other objects. Non-limiting examples of straps include belts, backpack straps, purse straps, suspenders, some types of jewelry (e.g some bracelets, necklaces, anklets), and the like.

With regard to manufacturing, some straps are made by weaving materials together. As an example, a mere two-inch-wide nylon vehicle tow/recovery strap may be rated at 20,000 lbs. break strength. Webbing is a particular type of strap that is a strong fabric woven as a flat strip or tube that is also often used in place of rope. Modern webbing is typically made from exceptionally high-strength material, and is used in automobile seat belts, furniture manufacturing, transportation, towing, military apparel, cargo fasteners, and many other fields.

Some straps are formed by merely cutting or shaping larger materials into elongated portions, such as cutting a sheet of leather into strips, thereby forming leather straps that may be made into belts, etc. Other straps are formed in molds, such as by stamping or injection molding plastics to form plastic straps that may be used with toys, clothing, etc.

Turning to domed products, some labels are formed by depositing clear urethane over printed adhesive labels and hardening the clear urethane to form a dome over the label. The labels, generally similar to a coin or business card in shape and size, are then removed from a backing sheet when ready to apply. The side opposite the dome is coated with an adhesive. The label, once removed from the backing sheet, is applied to a surface, usually on a prominent location on a product. There the label is secured by the adhesive and generally lays flat against the surface while displaying information and/or design from the label through the clear dome.

Some improvements have been made in the field. Examples of references related to the present invention are described below in their own words, and the supporting teachings of each reference are incorporated by reference herein:

U.S. Pat. No. 7,713,628, issued to Botrie et al., discloses a cured coating or molded article prepared from a composition comprising an actinic-radiation curing polymer, wherein the composition is cured with actinic radiation at a temperature of at most 150.degree. C. to form the cured coating or molded article; wherein the cured coating or molded article has a thickness of at least about 0.5 mm and a hardness of about Shore A 90 to about Shore D 90.

U.S. Pat. No. 7,445,152, issued to Golabek Jr. et al., discloses a label system and method for label alignment and placement on a container. The label system includes a first label or a container whereby the first label includes alignment symbology and a second label having an alignment area corresponding to the alignment symbology of the first label. The second label is positioned on the container whereby the alignment area of the second label is aligned with the alignment symbology of the first label. Visibility enhancement indicia may be provided adjacent the alignment area to increase the visibility of the alignment area to the user. Other indicia may be used to align the container in a holder for bar code scanning.

U.S. Pat. No. 6,263,598, issued to Sullivan, discloses a domed stitchable display article having a substrate base formed from a laminated plastic and fabric. Printing images are applied to the upper surface and are encapsulated by a dome formed from a poly,urethane rubber. A barrier is applied to the upper surface to alter the surface tension of the upper surface and limit outward flow of polyurethane during the fabrication portion. The substrate base forms stitchable flange portions.

U.S. Patent Application Publication No.: 2013/0008589, by Kreutz, discloses a method for producing domed labels consisting of a base layer having a lower face provided with an adhesive layer, a cover layer connected to an upper face of the base layer and a support layer adhering removably to the adhesive layer, wherein: a composite comprising the base layer, the adhesive layer and the support layer is provided on a surface of the base layer that faces away from the adhesive layer with a quantity of a material of the cover layer in a flowable state by means of a dosing unit, the final shape of the cover layer being formed by means of a flow process of the material on the surface of the base layer and the material of the cover layer present in the final shape thereof being a least partially cured.

U.S. Patent Application Publication No.: 2013/0128555, by Brauser et al., discloses a flexible light transmitting device, comprising a printable layer, a backing layer, and a light-emitting diode strip disposed between the printable layer and the backing layer. The printable layer is translucent to permit transmission of light from the light-emitting diodes through the printable layer when the light-emitting diodes are activated; however, the LED strip remains hidden between the layers. The printable layer is adapted to receive printed indicia by way of thermal printing process. The backing layer is substantially opaque comprises a durable nylon webbing or polypropylene material. The embedded LED strip comprises an elongated flexible casing containing spaced apart light-emitting diodes, one or more light interrupting spacers, and at least one ribbon wire extending through the casing and electrically coupling said light-emitting diodes. The light-emitting diodes are electrically coupled to a switch assembly which provides the LED switch with a plurality of operative modes.

The inventions heretofore known suffer from a number of disadvantages which may include one or more of: being not durable, being difficult to clean, being not clear, being rigid, being uncustomizable, being limited in shape and size, being not safe, being not stylish, being not waterproof, being expensive to manufacture, being limited in shape or size, being a haven for bacteria, being plastically deformable, being difficult to use, and having vulnerable internal components.

What is needed is a strap and a method of manufacture that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available straps. Accordingly, the present invention has been developed to provide a flexible and durable strap and the method of manufacturing thereof.

According to one embodiment of the invention, there is a strap that may include an elongated flexible substrate that may have a first side and a second side. The strap may include a solid dome of polymer resin that may be disposed over a majority of the first side of the elongated flexible substrate. The second side of the elongated flexible substrate may be free of adhesives.

The strap may include a second solid dome that may be disposed on the second side. The substrate length may be greater than four times the substrate width. The strap may include a decorative layer that may be disposed between the first side and the solid dome. The strap may include a decorative element that may be embedded with the solid dome. The polymer resin may be urethane. The substrate may be tear resistant. The strap may include a coupling device that may be disposed at a first end of the strap and may include a structure that couples to a second end distal from the first end. The strap may include an electronic device that may be imbedded in the solid dome. The polymer resin may be chemically inert and transparent.

According to one embodiment of the invention, there is a method of manufacturing a strap. The method may include the step of providing a flexible substrate that may have a first side and a second side. The second side may include a release agent and may be coupled to a backing sheet by an adhesive layer that may be coupled against the release agent. The method may include the step of applying a liquid polymer resin over a majority of the first side of the elongated flexible substrate. The method may include hardening the liquid polymer resin. The method may include the step of separating the flexible substrate from the adhesive layer.

The method of manufacturing a strap may include the step of applying and hardening a liquid polymer resin on the second side. The method may include the step of printing a decorative layer on the first side. The method may include cutting the flexible substrate and removing flexible substrate material between cuts leaving an array of strap shaped substrates. The step of hardening the liquid polymer resin may include the step of hardening by applying heat and wherein the liquid resin may be a thermosetting resin. The method may include adhering a carrier sheet (adhesive layer) to one of the flexible substrate or the hardened resin. The method may include removing the carrier sheet without leaving any adhesive on the flexible substrate or the hardened resin. The method may include the step of coating the second side of the flexible substrate with a release agent.

The method of manufacturing a strap may include the step of disposing a decorative object inside the liquid polymer resin. The decorative object may include an electronic device. The method may include the step of attaching a coupling device to an end of the flexible substrate. The step of hardening the liquid polymer may include positioning the substrate in a non-flat configuration during the hardening step such that the strap is produced with a non-flat biased configuration.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a side elevational cross-sectional view of a strap, according to one embodiment of the invention;

FIG. 2 is a side elevational cross-sectional view of a strap, according to one embodiment of the invention;

FIG. 3 is a side elevational cross-sectional view of a strap, according to one embodiment of the invention;

FIG. 4 is a perspective view of a strap, according to one embodiment of the invention;

FIG. 5 is a perspective view of a strap, according to one embodiment of the invention; and

FIG. 6 is a flowchart of a method of manufacturing a strap, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

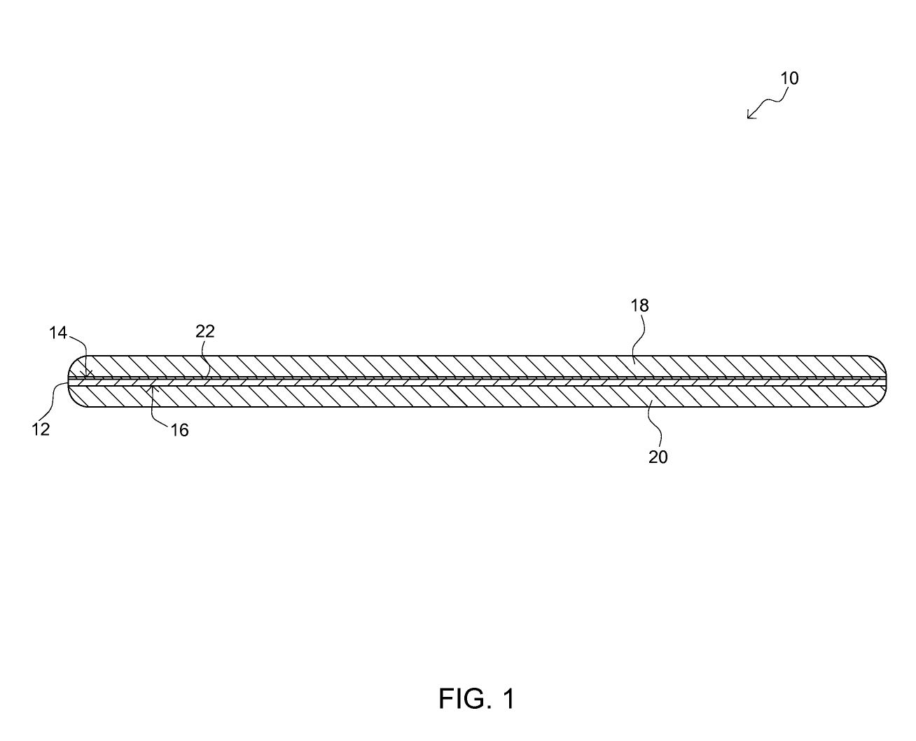

FIG. 1 is a side elevational cross-sectional view of a strap, according to one embodiment of the invention. There is shown a strap 10 including an elongated flexible substrate 12 having a first side 14 and a second side 16 and two solid domes of polymer resin 18, 20 disposed on opposite sides of the flexible substrate 12. There is a decorative layer 22 disposed between the elongated flexible substrate 12 and the dome of polymer resin 18 that is disposed across the first side of the elongated flexible substrate 12. Wherein the polymer resin is transparent, at least on the first side, the decorative layer is visible from an exterior of the strap. Depending on its other characteristics (e.g. strength, flexibility, length, width, thickness) which may be determined by selection of materials to be used in the manufacture thereof, such a strap may be utilized for a great variety of purposes, including but not limited to being a belt, bracelet, purse strap, backpack strap, connector, tie, wrap, anklet, necklace, weightlifting strap, clothing (e.g. shoulder straps for shirts/dresses), suspenders, packaging strap, band, collar, bungee, harness, backstrap, guitar straps, camera strap, shoe strap, lacing, wrist brace, binding, cuff, sling, headband, goggle strap, arm band, zip-tie, load-strap, luggage strap, decorative strap, tag, hang-tag and the like and combinations thereof.

The illustrated strap 10 includes a flexible substrate 12 having a first side 14 and a second side 16. The strap 10 includes a solid dome of polymer resin 18 that is disposed over a majority of the first side 14 of the elongated flexible substrate 12. The illustrated strap 10 includes a second solid dome 20 that is disposed on the second side 16 of the elongated flexible substrate 12. The illustrated polymer resin 18, 20 is urethane. The illustrated substrate 12 may be tear resistant and/or non-porous with regard to the liquid polymer resin. The polymer resin 18, 20 is generally chemically inert and transparent. The strap may be elongated (i.e. longer than it is wide) and may be elongated to a degree such that it is longer than it is wide by a ratio greater than or equal to π:1, 3.5:1, 4:1, 5:1, 6:1, 7:1, 8:1, 9:1, and/or 10:1 or greater. It is recognized that an elongated object that is longer than it is wide by an amount that equal to or less than π:1 (which may be expressed as being less than about 4:1) will generally not function well in the capacity of what should be a strap since straps are often formed into curved and/or cylindrical structures during the use thereof. Conversely, a strap will generally have a length to width ratio of greater than about 4:1.

Wherein the elongated object is not substantially longer than it is wide, the curvature thereof will form structures that have a width of comparable size to the radius/diameter of curvature, thus causing the width of the object to get in the way of the operation thereof. The ratio of π:1 is obtained from the formula for calculating the circumference of a circle, which is 2πr (alternatively expressed as πD), wherein the circumference of a circle formed by an elongated member would correspond to the length thereof. One need only imagine wearing a belt that is over a foot wide to comprehend this issue at a common level. While such is technically possible, such a belt verges on being a corset and would not be a strap according to the usage of the word strap as defined herein.

In one non-limiting embodiment, there is a functional graphic strap that may be domed with a material such as but not limited to urethane that is deposited in a liquid form, having just been mixed with a catalyst (e.g. an isocyonate catalyst), and then cured into a hardened dome. Such may include a full color graphic protected in a durable and flexible way. There may be a dome of clear and flexible urethane that encompasses/engulfs a graphic or other decorative element. The dome may be of an epoxy resin, a UV-curable urethane (and/or other polymers), silicone, and/or thermoset plastic(s) and the like and combinations thereof. Such a dome may be transparent, translucent and/or opaque (entirely or along portions/layers thereof). Generally the dome will be of a material that is initially liquid, so that it may be poured/squirted onto the substrate and then cured to harden the same, usually by application of time/heat/UV or other energy, which is understood to more fully cross-link the resin, thus hardening the same. Wherein the substrate is raised from an adjacent surface and the edge of the substrate is formed at a sharp angle (usually at around a 90 degree angle away from the surface of the substrate) surface tension within the fluid dome material will keep the same within the confines of the top surface of the substrate if otherwise undisturbed while the liquid dome material is cured. Once cured, the material may be handled, even roughly, without substantially disturbing the distribution of dome material adjacent to the substrate.

The graphic is associated with and/or coupled to (e.g. inlaid, glued to, overlaid, printed on, etched into, deposited on, spaced from) a substrate which adds strength to the overall structure. The substrate may be of a material similar to those which are used to make banners, as such are generally, because of their intended use, required to be durable, flexible and resistant to tearing and deformation. Non-limiting examples of substrate materials include: Transalloy P-300 Litho Gr Sq Cut, sold by Transilwrap Company, Inc. of Franklin Park, Ill.; woven plastic fibers; scrim vinyl; polyester scrim; and PVC coated polyester scrim. In various non-limiting embodiments, the substrate may be removable, may be removed after manufacture and not replaced, may have never been present, or may consist of a polymer resin dome.

The strap may include a closure/attachment device/structure to connect it to other members or to attach to itself, such as but not limited to mating hook-and-loop structures (e.g. Velcro brand products), buckles, clamps, tongue-and-groove structures, snaps, buttons, clips, ties, friction-fittings, and the like and combinations thereof and such may be selectably coupleable/decouplable. Such a device/structure may be embedded into the dome and/or otherwise coupled thereto, such as but not limited to by snaps, pins, rivets, stitching, hooks, bolts, screws, nails, and the like and combinations thereof and while such may be selectably coupleable/de-coupleable, it will generally be more of a permanent attachment.

Other devices/structures may be embedded (fully engulfed and/or only partially engulfed) into the dome as well, including but not limited to decorative elements, RFID chips, magnets, materials/devices/layers that are highly reflective, gemstones, sand or other texturing materials, electronic components (e.g. batteries, transmitters, transponders, LEDS, processors, memory, power conduits/wires, OLED), unique identifiers (e.g. bar codes, QR codes), decorative objects and the like and combinations thereof.

In one non-limiting embodiment, there is a strap including a domed substrate without an adhesive.

In another non-limiting embodiment, there is a process of manufacturing a adhesive-free domed strap.

In still another non-limiting embodiment, there is a domed strap including a substrate resistant to deformation and/or to tearing.

In still yet another non-limiting embodiment, there is a domed substrate including coupling devices/structures to couple to itself.

In still yet another additional non-limiting embodiment, there is a strap having a domed substrate with decorative layer that is protected by the dome.

Advantageously, cured urethane is generally inert and durable and therefore protects the decorative element, which may not share those properties. Further, a urethane dome gives the graphic (which is generally printed on the substrate, but may be overlayed, glued to, or otherwise associate with and/or coupled to the substrate) a visible enhancement. The strap may be domed on one or both sides. Wherein the substrate is tear-resistant and/or deformation resistant (i.e. elastically deformable and not likely to experience hysteresis under a range of expected operating deformations) provides additional strength and durability to the same. Advantageously, a strap as described herein, may have properties of high durability, be tear-resistant, deformation resistant (sometimes described as being “self-healing”), able to withstand large ranges in temperatures, solvent resistant, weathers very well even if exposed to the elements, and is highly decorative and customizably so. Such straps may be utilized in a tremendous variety of industries and markets and the manufacture thereof may adapt to changing fashions, fads, and requirements.

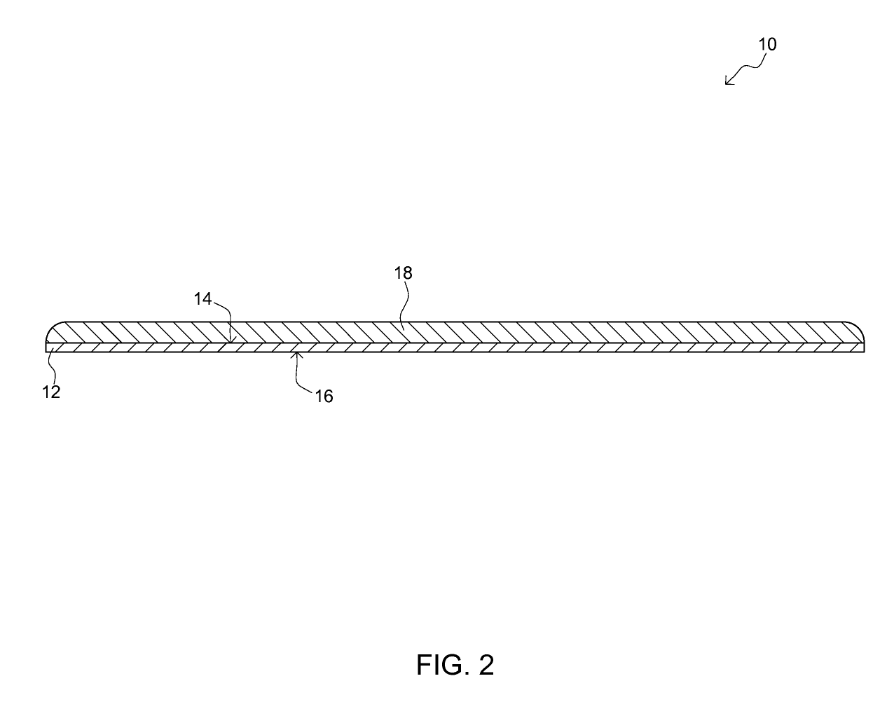

FIG. 2 is a side elevational cross-sectional view of a strap, according to one embodiment of the invention. There is shown a strap 10 including an elongated flexible substrate 12 having a first side 14 and a second side 16 and a solid dome of polymer resin disposed over the first side 14 but not domed over the second side.

The illustrated strap 10 includes an elongated flexible substrate 12 having a first side 14 and a second side 16. The strap 10 includes a solid dome of polymer resin 18 disposed over a majority of the first side 14 of the elongated flexible substrate 12. The illustrated second side 16 of the elongated flexible substrate 12 is substantially free of adhesives, such that while minute amounts of adhesive may be present, such as but not limited to tiny amounts that may have survived release from an adhesive sheet wherein the substrate formed a backing layer thereto, the amounts are not sufficient to cause the substrate to persistently adhere to other materials in opposition to the weight of the strap.

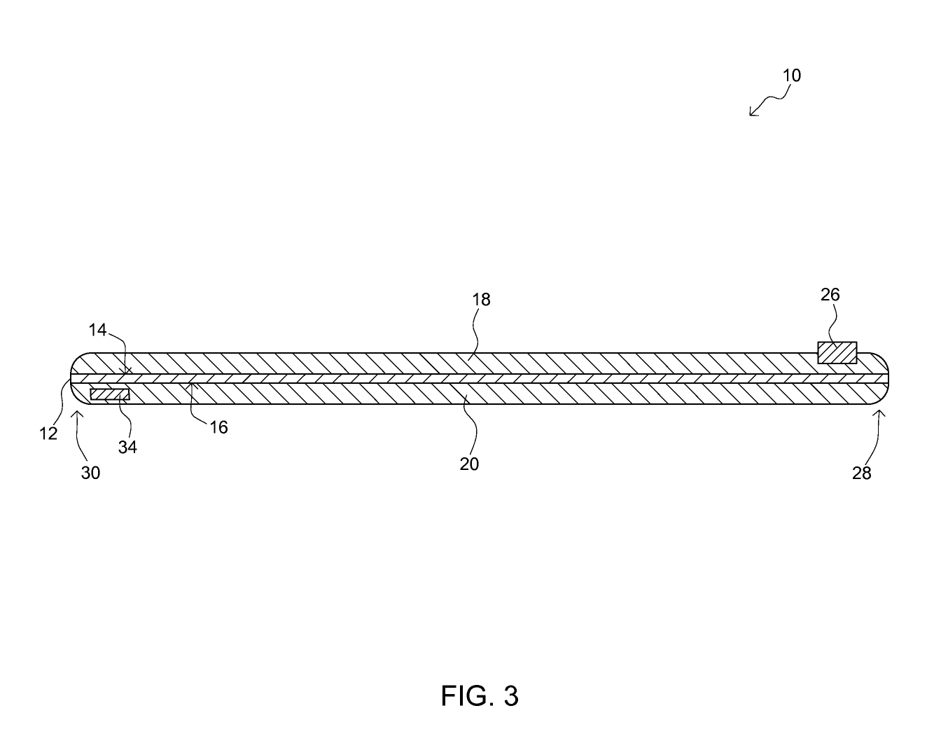

FIG. 3 is a side elevational cross-sectional view of a strap, according to one embodiment of the invention. There is shown a strap 10 including an elongated flexible substrate 12 having a first side 14 and a second 16, both including a solid dome of polymer resin disposed thereover, and a coupling device 26 and a structure 34 disposed within the solid dome of polymer resin.

The illustrated strap 10 includes an elongated flexible substrate 12 having a first side 14 and a second side 16. The strap 10 includes a solid dome of polymer resin 18 disposed over a majority of the first side 14 of the elongated flexible substrate 12. The strap 10 includes a second solid dome 20 disposed on the second side 16.

The illustrated strap 10 includes a coupling device 26 disposed at a first end 28 of the strap 10 and includes a structure 34 that couples to a second end 30 distal from the first end 28. The illustrated coupling device 26 is substantially embedded (but not fully engulfed) into the solid dome of polymer resin 18 of the first side 14 of the elongated flexible substrate 12, wherein the coupling device 26 is extending out from the solid dome of polymer resin 18. The illustrated structure 34 is disposed within (and fully engulfed thereby) the solid dome of polymer resin 20 of the second side 16 of the elongated flexible substrate 12. The coupling device 26 and the structure 34 may be partially embedded, fully embedded, or a mixture of both for coupling a first end 28 of the strap 10 to a second end 30 of the strap 10.

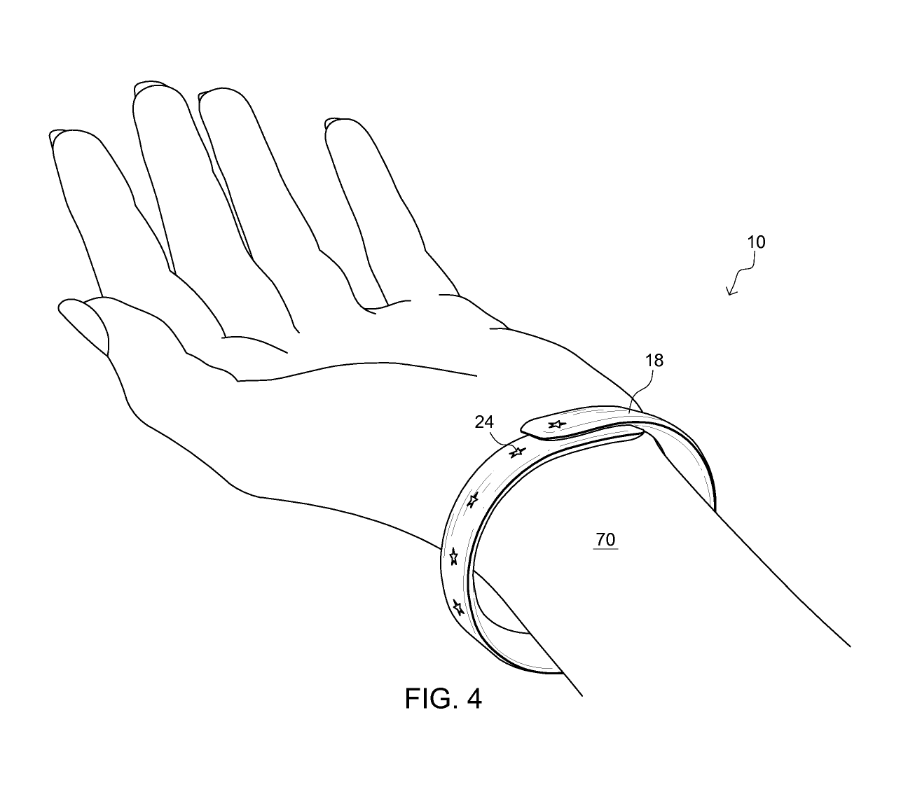

FIG. 4 is a perspective view of a strap, according to one embodiment of the invention. There is shown a strap 10 coupled to wrist of a user 70.

The illustrated strap 10 includes a solid dome of polymer resin 18 disposed over a majority of a first side of the elongated flexible substrate. The illustrated strap includes a decorative element 24 embedded with the solid dome of polymer resin 18. The illustrated strap 10 includes a coupling device disposed at a first end of the strap and includes a structure that couples to a second end distal from the first end. As illustrated the strap 10 is coupled about a wrist of a user 70.

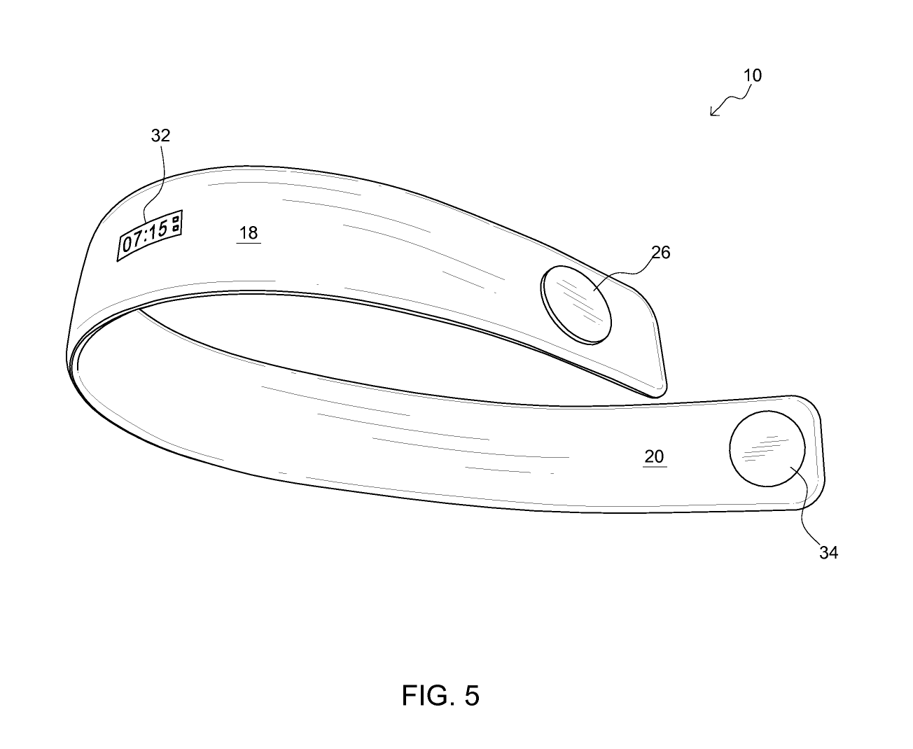

FIG. 5 is a perspective view of a strap, according to one embodiment of the invention. There is shown a strap 10 including a solid dome of polymer resin 18, 20 disposed on both sides of the strap 10, and including an electronic device 32 disposed therein.

The illustrated strap 10 includes an elongated flexible substrate having a first side and a second side. The strap 10 includes a solid dome of polymer resin 18, 20 disposed over a majority of the first side and the second side of the elongated flexible substrate. The illustrated strap 10 includes a coupling device 26 disposed at a first end of the strap 10. The strap 10 also includes a structure 34 that couples to a second end distal from the first end. The coupling device 26 and the structure 34 are configured to couple together, thereby forming a band. The illustrated strap 10 includes an electronic device 32 imbedded in the solid dome of polymer resin 18 on the first side of the strap 10. The electronic device 32 may be a clock, a pedometer, a MP3 player, or any other electronic device including a self-enclosed power source. The electronic device 32 may also be selectably removable from the solid dome of polymer resin 18.

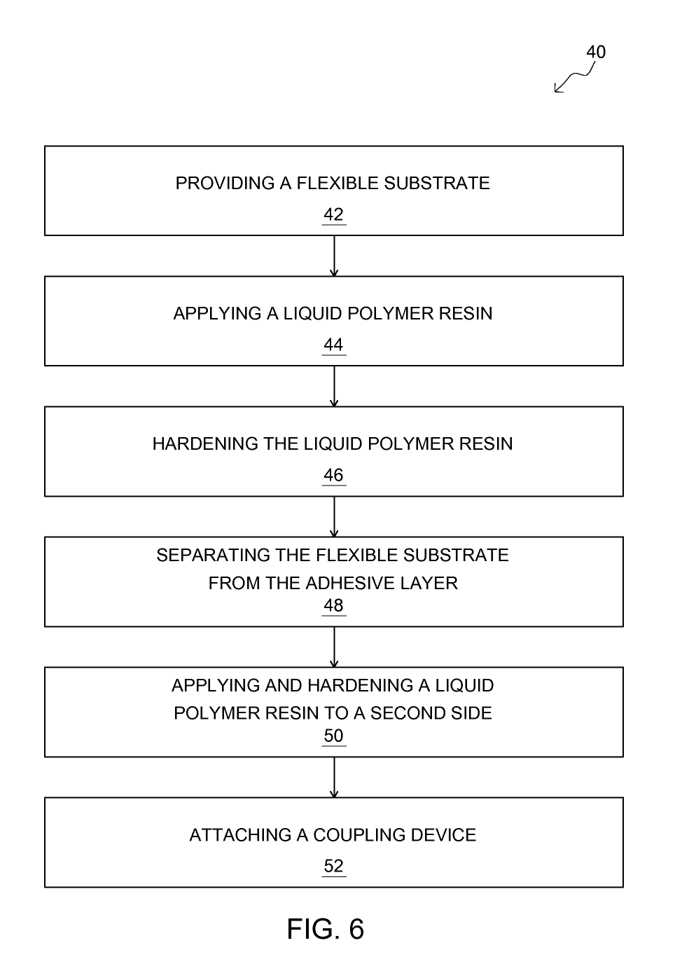

FIG. 6 is a flowchart of a method of manufacturing a strap, according to one embodiment of the invention. There is shown a method of manufacturing a strap 40.

The illustrated method of manufacturing a strap 40 includes the step of providing a flexible substrate having a first side and a second side 42. The substrate is a flat elongated member of woven fibers, such as but not limited to scrim. The sign industry offers a variety of scrim banner substrates often with polyester strands in a woof/warp configuration in varying strengths from 100-1,000 denier. Scrim reinforcement is often sandwiched between two fused layers of vinyl that act as the ink receptive, non-porous carrier for the urethane. While many substrates can be used, applicant has successfully produced domed straps using the following substrates:
Zeelon, 13 Ounce, 1000×1000 denier, Ink Jet, Vinyl, Banner Material UltraFlex 18 Ounce, 1000×1000 denier, Double-Sided Blockout Scrim Banner Flexcon—FLX000217 ALPHAMAX 600, 6-mil polypropylene Flexcon—FLEXMARK PM 700 WHITE NO PS 2, 7-mil polyester

Generally, non-scrim substrates are best for applications with minimal tensile and tear-strength requirements such as bracelets while scrimmed substrates are more suitable for dog collars, gun straps and waist belts, wherein additional strength may be required.

Sign industry banner material is often supplied in width that are too large for many presses and will often require customization in both width and roll length. Substrates may also include special coatings to improve ink receptivity matched to the print technology in use often changing the surface energy of the substrate such as but not limited to coatings sold under the brand Topaz by Tekra of New Berlin, Wis.; TC-200 FlexCon of Spencer, Mass.; and TC-413 of FlexCon of Spencer, Mass.

Wherein the substrate is not already provided in strap shaped units, the method 40 includes cutting the flexible substrate and removing flexible substrate material between cuts leaving an array of strap shaped substrates. Such may be accomplished by kiss-cutting through the backing layer, which is also the substrate layer and leaving the adhesive layer uncut. Such a structure permits the adhesive layer to maintain relative positioning and orientation of the substrates, thus enhancing and easing the further processing of the same using machines.

The method 40 includes adhering a carrier sheet to one of the flexible substrate or the hardened resin. The method 40 includes removing the carrier sheet without leaving any adhesive on the flexible substrate or the hardened resin. Such may be accomplished by applying transfer tape (which generally includes a very weak adhesive that is strongly bonded to the tape), a carrier sheet with a removable adhesive (e.g. gummy adhesives, 3M Removable Adhesive by 3M of St. Paul Minn., a static cling sheet (e.g. sheets of vinyl with built in static charges and thus adhere without chemical adhesive), a carrier sheet with a strong adhesive in conjunction with application of a release agent applied to the substrate and/or hardened resin, a magnetized sheet (wherein the substrate or hardened resin is magnetically active and thus adhere without chemical adhesive) across the flexible substrate and/or hardened resin, and the like and combinations thereof. Such carriers may be applied to the substrate and/or resin and will hold the same in place for further processing, but when removed will not leave behind substantial amounts of adhesive. As a non-limiting example of use of multiple various carrier sheets as described above, there may be a carrier sheet coupled to a sheet of a flexible substrate by a removable adhesive. The flexible substrate may be kiss-cut and portions thereof removed to form islands of elongated flexible substrate material adhered to the carrier sheet. The carrier sheet may be run through an automated resin deposition machine that deposits liquid resin on the islands of substrate. Once cured, a wide transfer tape may be applied across the tops of the hardened resin, the entire length flipped over and then the original carrier sheet may be pulled away from the islands of flexible substrate. Thus the transfer tape is a new carrier sheet which is then run through the same automated deposition machine that deposits resin on the opposite side of the substrate. The second set of domes may then be hardened and either transferred to a third carrier sheet (which could be any of those listed above or others not listed), stored/delivered attached to the transfer tape, or may be removed therefrom and bundled/packaged without a carrier sheet.

The method 40 includes the step of coating the second side of the flexible substrate with a release agent. The second side may include a release agent (generally for adhesive release, such as but not limited to release agents disposed on backing sheets for stickers, Release Agent by 3M of St. Paul, Minn., silicone acrylate, wax, oils, and the like and combinations thereof) that may be applied during the manufacturing process described herein, may be pre-applied and/or may be a natural constituent of the substrate. The substrate may be coupled to a backing sheet by an adhesive layer that may be coupled against the release agent.

The method 40 includes the step of printing a decorative layer on the first side of the substrate. Such may be accomplished by use of industrial printers configured to print on such substrates, generally depositing ink across the surface of the same. Applicant has successfully used Roland VersaUV LEC-330 30″ UV-LED Inkjet Printer/Cutters to apply graphics to the above substrates custom cut to a 30″ roll width without alteration to the stock print treatment.

The method 40 includes the step of applying a liquid polymer resin over a majority of the first side of the elongated flexible substrate 44. Generally, the liquid resin is formed by mixing a fluid polymer with a catalyst and then depositing the mixture over the elongated flexible substrate while the mixture is still capable of the appropriate flow needed for the deposition process. The deposition process may be applied across a plurality of substrates on a production line. The method of manufacturing a strap includes the step of disposing an object inside the liquid polymer resin. The object may include an electronic device, a decorative object or other similar devices/structures, described herein. Such may be placed before, during or after portions of the hardening processes descried below, depending on how the objects are to be embedded within the urethane matrix. It is advantageous during the doming process (applying the resin and hardening the same) to maintain the substrate in a desired configuration. Accordingly, it is beneficial to use a device/structure/process such as but not limited to a vacuum board to keep a substrate flat while doming.

The method 40 includes the step of hardening the liquid polymer resin. 46. Depending on the particular resin and/or catalyst used, the hardening process may include one or more of the following: applying heat, applying UV energy, waiting for a period of time, subjecting the resin to additional chemical treatments, exposing the resin to particular environmental conditions (controlled humidity, air filtration, etc.). Once the first side is domed and sufficiently hardened, the method of manufacturing a strap may include the step of applying and hardening a liquid polymer resin on the second side using the same or similar techniques. The step of hardening the liquid polymer may include positioning the substrate in a non-flat configuration (generally over a curvature) during the hardening step such that the strap is produced with a non-flat biased configuration. This may be particularly useful wherein the end strap needs to have a non-flat bias to its shape and such may be useful in enhancing the comfort, safety and/or utility of the strap. Once hardened into a particular shape, urethane (and other similar materials) will have a memory of that shape that may last many years and will generally revert back to that shape unless continually forced into another shape.

The method 40 includes the step of separating the flexible substrate from the adhesive layer 48. This step may be delayed and/or performed by a third party assembler who may be assembling the final strap. The separating step may be performed by running the adhesive layer across a drum having a curvature such that the adhesive layer continues across the curvature while the hardened strap fails to keep to that same curvature and is thus ejected from the moving adhesive layer.

The illustrated method 40 includes the step of applying and hardening a liquid polymer resin to a second side of the elongated flexible substrate 50. The method 40 includes the step of attaching a coupling device to an end of the flexible substrate 52, such as but not limited to riveting a buckle to one end and/or punching holes through the other end of the strap, affixing mating snaps to each end, embedding a magnet and/or a magnetically active material into an end, friction coupling a clip to an end, and the like and combinations thereof.

The following are examples of variations of the above mentioned steps that may be present in one or more embodiments of the invention: double-sided printing, double-sided printing from one side by printing on a substrate that either allows the ink to penetrate the substrate or on a substrate that is sufficiently transparent/translucent such that the printing can be seen from either side, through-cutting instead of kiss-cutting (especially wherein there is no adhesive layer), and providing multi-layer substrates.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A strap, comprising:
a) an elongated flexible substrate, having a first side and a second side;
b) a solid dome of polymer resin disposed over a majority of the first side of the elongated flexible substrate; and
c) wherein the second side of the elongated flexible substrate is free of adhesives.

2. The strap of claim 1, further comprising a second solid dome disposed on the second side.

3. The strap of claim 1, wherein the substrate length is greater than four times the substrate width.

4. The strap of claim 1, further comprising a decorative layer disposed between the first side and the solid dome.

5. The strap of claim 1, further comprising a decorative element embedded with the solid dome.

6. The strap of claim 1, wherein the polymer resin is urethane.

7. The strap of claim 1, wherein the substrate is tear resistant.

8. The strap of claim 1, further comprising a coupling device disposed at a first end of the strap and including structure that couples to a second end distal from the first end.

9. The strap of claim 1, further comprising an electronic device imbedded in the solid dome.

10. The strap of claim 1, wherein the polymer resin is chemically inert and transparent.

11. A method of manufacturing a strap, comprising the step of:
a) providing a flexible substrate having a first side and a second side;
b) applying a liquid polymer resin over a majority of the first side of the elongated flexible substrate; and
c) hardening the liquid polymer resin.

12. The method of claim 11, further comprising the steps of applying and hardening a liquid polymer resin on the second side.

13. The method of claim 11, further comprising the step of printing a decorative layer on the first side.

14. The method of claim 11, further comprising adhering a carrier sheet to one of the flexible substrate or the hardened resin.

15. The method of claim 12, wherein the step of hardening the liquid polymer resin includes the step of hardening by applying heat and wherein the liquid resin is a thermosetting resin.

16. The method of claim 14, further comprising removing the carrier sheet without leaving any adhesive on the flexible substrate or the hardened resin.

17. The method of claim 11, further comprising disposing a decorative object inside the liquid polymer resin.

18. The method of claim 17, wherein the decorative object includes an electronic device.

19. The method of claim 11, further comprising attaching a coupling device to an end of the flexible substrate.

20. The method of claim 11, wherein the step of hardening the liquid polymer includes positioning the substrate in a non-flat configuration during the hardening step such that the strap is produced with a non-flat biased configuration.
